(19) United States
(12) Patent Application Publication
(10) Pub. No.: US 2026/0046050 A1
(43) Pub. Date: Feb. 12, 2026

(54) TIME SYNCHRONIZATION OF DEVICES

(71) Applicant: Intel Corporation, Santa Clara, CA (US)

(72) Inventors: Kishore KASICHAINULA, Johns Creek, GA (US); Lukasz KURYLO, Gdansk (PL); Parameshwari BHAT, San Jose, CA (US); Marcin SZKUDLINSKI, Santa Clara, CA (US)

(21) Appl. No.: 19/361,616

(22) Filed: Oct. 17, 2025

(51) Int. Cl. H04J 3/06

(52) U.S. Cl. CPC H04J 3/0638

(57) ABSTRACT

Examples described herein relate to a network interface device comprising: a direct memory access (DMA) circuitry; a device interface; a network interface; and a circuitry to: transmit a clock reference frame to multiple talker devices at a predefined rate to cause the multiple talker devices to synchronize clock signals with a time stamp value in the clock reference frame. In some examples, the circuitry is to synchronize a leading edge of a media clock signal based on the time stamp value and provide the media clock signal to an media processing system.

Time sensitive networking provides precise scheduling of data transmission and scalability while reducing wiring weight and cost. Institute of Electrical and Electronics Engineers (IEEE) has defined standards (IEEE 1588 and 802.1AS) to achieve time synchronization across devices connected to a network. The Generalized Precision Time Protocol (gPTP) provides a system to precisely synchronize follower Ethernet devices network clock signals (PTP clock) across the network to a grandmaster (GM) clock.

### BRIEF DESCRIPTION OF THE DRAWINGS

FIG. 1 depicts an example system.

FIG. 2 depicts an example of a dictionary creation mode.

FIG. 3A depicts an example of a dictionary creation and data compression mode.

FIG. 3B illustrates an example of audio data transfer.

FIG. 4 shows an example process.

FIG. 5 depicts a system.

### DETAILED DESCRIPTION

With the advent of IEEE 802.1 Time Sensitive Networking (TSN) standards, automotive applications are utilizing TSN capable Ethernet controllers in network interface devices. In applications such as automotive or theaters, multiple talker devices and listener devices are utilized, such as multiple microphones and speakers in the front and rear passenger seats. However, other applications are possible.

For time synchronized playback of media received from multiple talker devices, a media system clock signal and talker device clock signals are to be synchronized to one another. According to various examples described herein, clock signals of multiple talker devices can synchronize with a clock signal of a network interface device associated with a media subsystem. A network interface device utilized by the media subsystem can generate clock reference frames (e.g., Institute of Electrical and Electronics Engineers (IEEE) 1722 Clock Reference Format (CRF) frames) based on a Grandmaster Clock (GM) (as an IEEE 1588 Precision Time Protocol (PTP) GM) or a corrected PTP clock (as a PTP follower). The network interface device can broadcast clock reference frames on the network at a defined rate (e.g., 300 Hz or other frequencies), to one or more talker devices and the media subsystem. Talker devices can synchronize clock signals to time stamps of the clock reference frames for phase and frequency synchronization. In addition, the network interface device can recover a media clock from the broadcasted clock reference frames and provide the recovered media clock to the media subsystem. The media subsystem can use the recovered media clock for timing playback of a media stream from talker devices. Various examples permit scaling a number of talkers and listeners using packet-based time synchronization. Talker devices can receive media or transmit media data.

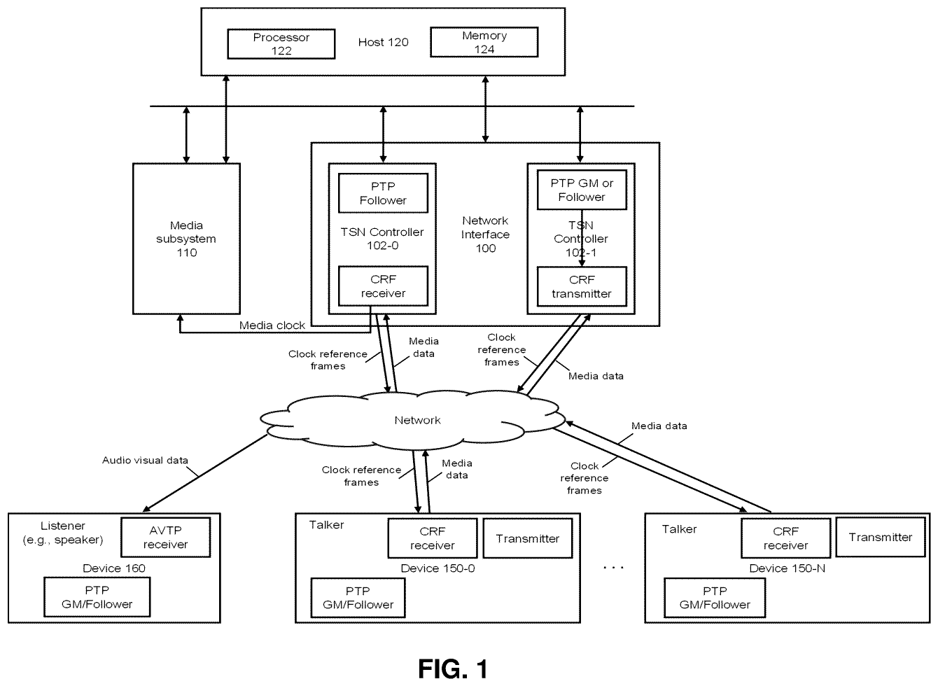

FIG. 1 depicts an example system. As described herein, network interface device 100 can transmit clock reference frames in packets to multiple talker devices 150-0 to 150-N to synchronize clock signals of multiple talker devices 150-0 to 150-N with a clock signal of media subsystem 110.

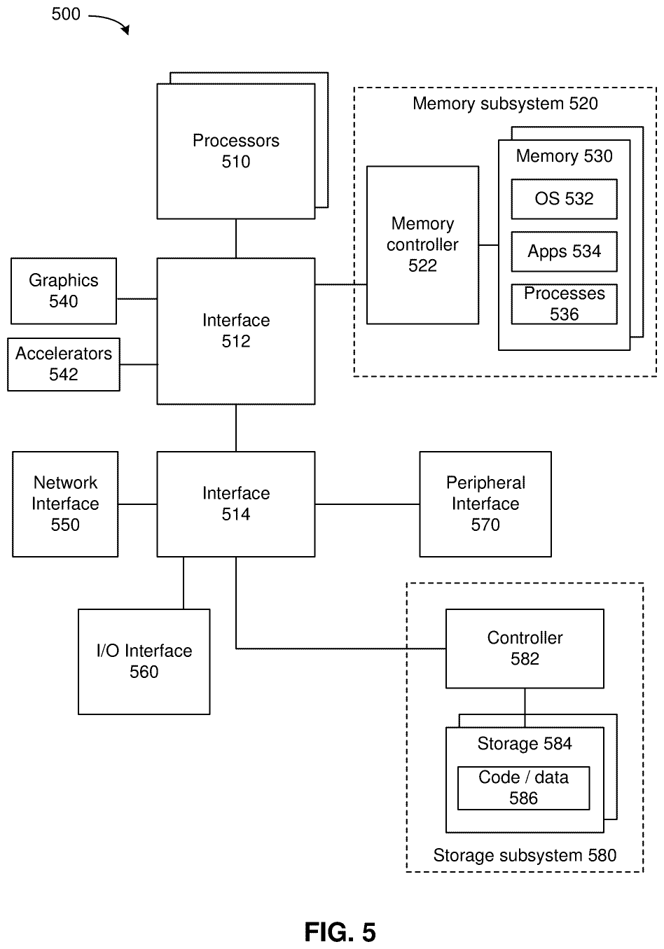

Processor 122 can execute a process, operating system (OS), driver, and other software described at least with respect to FIG. 5. A processor-executed network interface device driver can reserve transmit and receive direct memory access (DMA) channels and transmit and receive queues of network interface device 100 to respectively transmit and receive clock reference frames. As described herein, network interface device driver can configure a rate that clock reference frame generator circuitry generates clock reference frames and other parameters in the frame.

Network interface device 100 can transmit clock reference frames to at least talker devices 150-0 to 150-N. In some configurations, the timestamp frequency for a stream of clock reference frames can be lower than that of the media clock (e.g., audio sampling rate). For example, a timestamp frequency can be 300 Hz (e.g., for 48 kHz audio, there are 160 samples between timestamps), although other frequencies can be used. Network interface device 100 can utilize a port of TSN controller 102-1 for transmitting IEEE 1722 Clock Reference Format (CRF) frames and a second port at TSN controller 102-0 for receiving CRF frames from the transmitter port. A CRF frame can indicate a future time stamp value that is used to align with a rising edge of a talker clock signal and indicate a time stamp value when a talker device (e.g., one or more of talker devices 150-0 to 150-N) is to send media. Network interface device 100 can utilize multiple transmit and receive queues to respectively transmit and receive packets. In some examples, a device driver, executed by processor 122, can allocate high priority transmit queues and receive queues to respectively transmit or receive CRF frames and lower priority queues can be used for media data transmission or reception.

One or more talker devices 150-0 to 150-N can synchronize clock signals to the time stamps from CRF frames for phase and frequency synchronization with a clock signal of network interface device 100 despite different propagation delays from the network interface device 100 to the talker devices. Clock signals of talker devices 150-0 to 150-N can be synchronized based on PTP and the time stamps in the CRF frames.

Based on CRF frames received by a port at TSN controller 102-0, network interface device 100 can recover a media clock and provide the recovered media clock to media subsystem 110, as described herein. Media subsystem 110 can use the media clock as a base clock and send or receive audio samples through a fabric or other interface. While examples are described with respect to audio processing, media subsystem 110 can generate media data (e.g., video, images, metadata, or other data). Media subsystem 110 can output media data and transmit the media data in one or more packets to listener device 160. Listener device 160 can receive media data and generate audible audio and/or visible video timed according to a clock signal. Various examples can be utilized in an automobile, theater, virtual reality (VR) environment, or other systems.

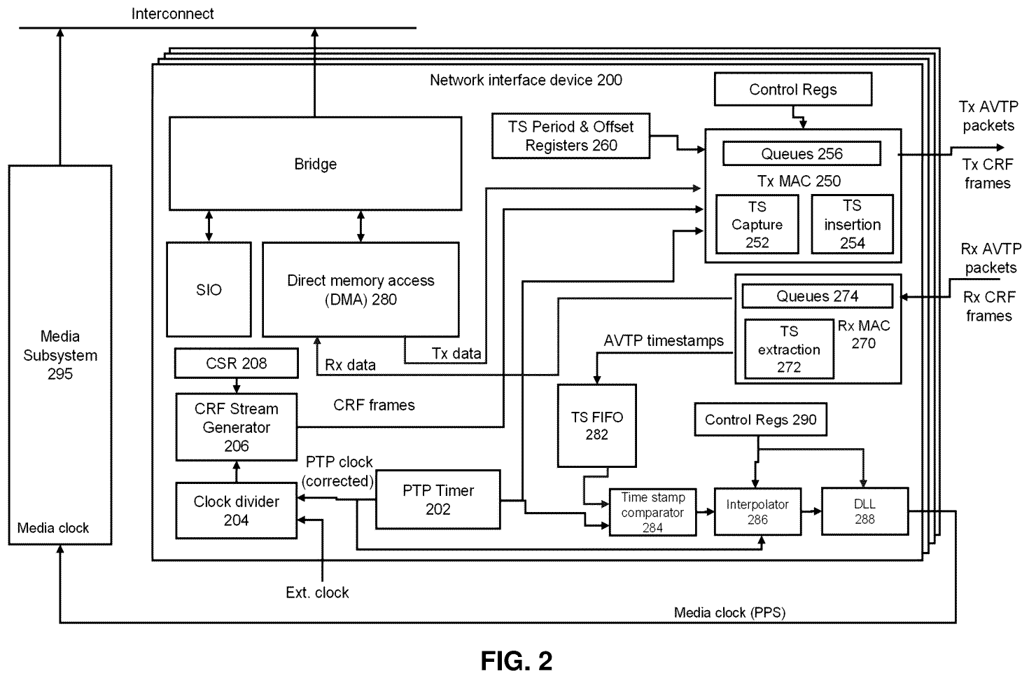

FIG. 2 depicts an example network interface device. Media subsystem 110 and one or more talker devices 150-0 to 150-N can utilize network interface device 200 to synchronize media clock signals. For example, network interface device 200 can include multiple TSN capable ports associated with TSN controllers 102-0 to 102-1. Although two ports are shown, other numbers of ports can be used. The following is an example of operations to generate time stamps for CRF frames for transmission to one or more listener devices to synchronize clock signals with a clock signal of network interface device 100. PTP timer 202 can synchronize a clock signal based on IEEE 1588. PTP timer 202 can generate a PTP clock (corrected) as a grand master or follower. Clock divider 204 can adjust a frequency of PTP clock and output the adjusted frequency clock signal to CRF stream generator 206.

A network device driver executed by processor 122 can configure a frame rate (e.g., 300 Hz) and other parameters in the CRF stream generator 206. CRF stream generator 206 can generate a corrected PTP clock. The PTP clock can be based on PTP4L utility, which implements a gPTP algorithm, for synchronizing devices on the network. CRF stream generator 206 can generate IEEE 1722 CRF frames based on a configuration from configuration register (CSR) 208. CRF packets can include time stamps that mark time deltas between samples. For example, configuration from CSR 208 can indicate to generate a time stamp every 160 samples.

CRF packets can be egressed from a queue in Tx media access controller (MAC) 250. TS capture 252 can capture timestamps based on a PTP timer value from PTP timer 202. Timestamp (TS) period and offset registers 260 can indicate an offset of a TS from a beginning of a packet header. TS insertion 254 can insert TS at an offset into a packet. Tx MAC 250 can generate a Tx AVTP packet with a CRF frame in an IEEE 1722 Audio Video Transport Protocol (AVTP) packet. A packet header can indicate an AVTP packet includes a CRF frame based on IEEE 802.1qav.

For example, port 0 of network interface device 200 and associated transmit (Tx) queue 7 can be used for transmission of clock reference frames whereas port 1 and associated Rx queue 7 can be used for reception of clock reference frames.

The following is an example of operations to process time stamps from received CRF frames in AVTP packets transmitted by a network interface device port (e.g., port 0). Rx MAC 270 directs CRF frames into a high priority receive queue. Instead of frames in the high priority receive queue being copied by DMA 280 into memory (not shown), CRF frames can be copied into a local timestamp (TS) first in first out (FIFO) buffer 282. TS extraction 272 can identify and copy timestamps from received frames. As timestamps are future timed, these timestamps are to be buffered until PTP timer 202 lapses the timestamp value and time stamp comparator 284 generates an indicator on the PPS signal representing clock pulse that matches the talker device's media clock phase. Comparator 284 compares interpolated timestamps with PTP timer time stamp to determine when to generate pulse for a media clock. Based on a configuration from control registers (Regs) 290, timestamp (TS) interpolator 286 can generate interpolated values of the timestamps from TS FIFO buffer 282. TS interpolator 286 can insert one or more interpolated time stamps in between time stamps of Rx AVTP packets at a timing or frequency interval based on a configuration from control registers (Regs) 290. Delay-locked loop (DLL) 288 can generate a media clock signal with rising edges timed to the time stamp values and interpolated time stamp values and having a frequency specified by a frequency multiplier value specified in a configuration in control registers (Regs) 290.

An internal or external phase locked loop (PLL) (not shown) can multiply the media clock frequency for an media subsystem 295 that is connected to network interface device 200. Network interface device 200 can provide media clock to media subsystem to generate audio and/or video signals for output.

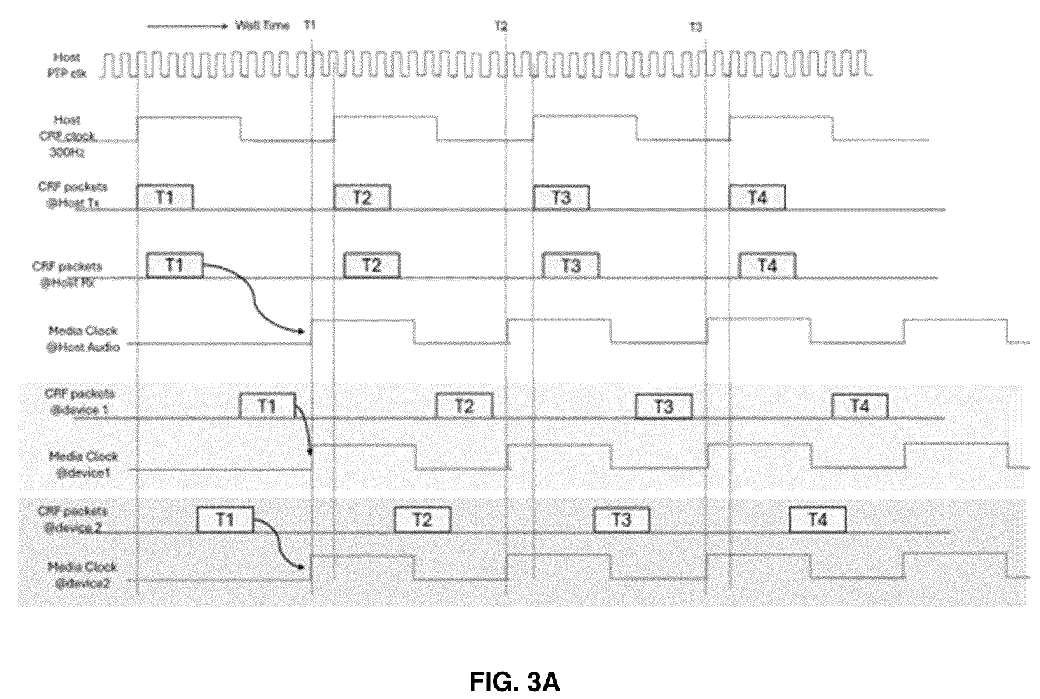

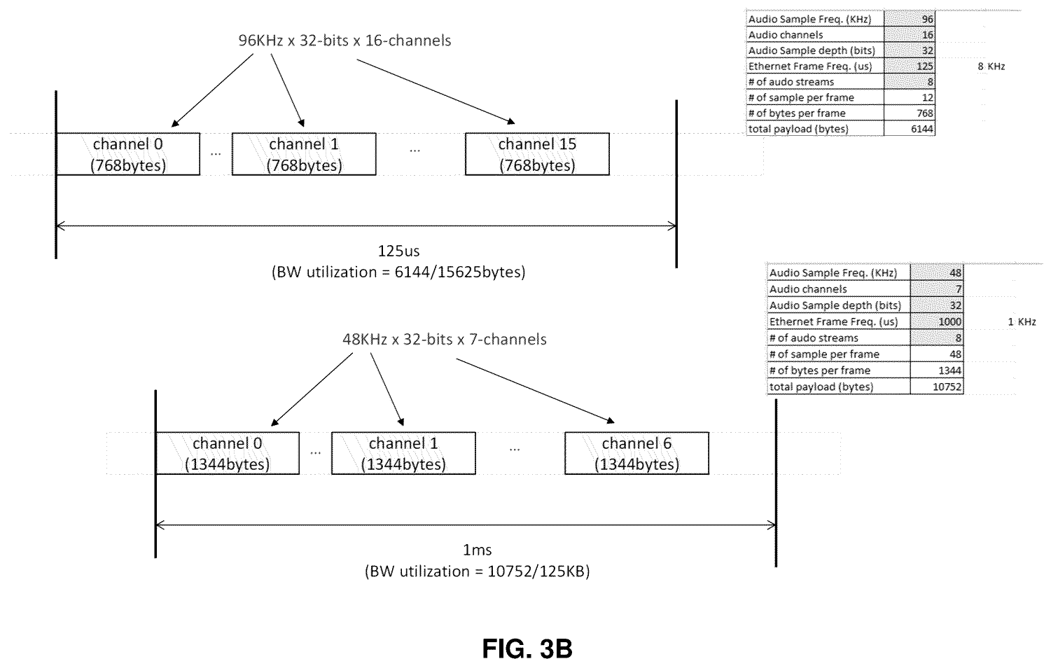

FIG. 3A depicts an example timing diagram. Network interface device can transmit a CRF frame with timestamp value T1 to device 1 and device 2. T1 can represent a timestamp value to which a device is to synchronize a rising edge of media clock signals of devices 1 and 2. After propagation of CRF with timestamp T1 to device 1, device 1 can cause the device 1 to adjust a phase of a media clock so that the rising edge of the media clock rises at time stamp T1. Similarly, after propagation of CRF to device 2, device 2 can cause the device 2 adjust a phase of a media clock so that the rising edge of the media clock rises at time stamp T1.

Network interface device can transmit a CRF frame with timestamp value T2 to device 1 and device 2. T2 can represent a timestamp value to which a device is to synchronize a rising edge of media clock signals of devices 1 and 2. After propagation of CRF with timestamp T2 to device 1, device 1 can cause the device 1 to adjust a phase of a media clock so that the rising edge of the media clock rises at time stamp T2. Similarly, after propagation of CRF to device 2, device 2 can cause the device 2 adjust a phase of a media clock so that the rising edge of the media clock rises at time stamp T2.

In a similar manner as those of CRF frames with T1 and T2, network interface device can transmit CRF with timestamps 3 and 4 to devices 1 and 2 to cause synchronization of media clock signals of devices 1 and 2 based on timestamps 3 and 4.

FIG. 3B illustrates an example of audio data transfer between a media subsystem and network interface device. The diagram shows examples of 96 KHz and 48 KHz media transmission over respective 125 μs and Ims time frames over multiple channels for a given time frame. The media data can be transferred between media subsystem and network interface device via a peer to peer fabric.

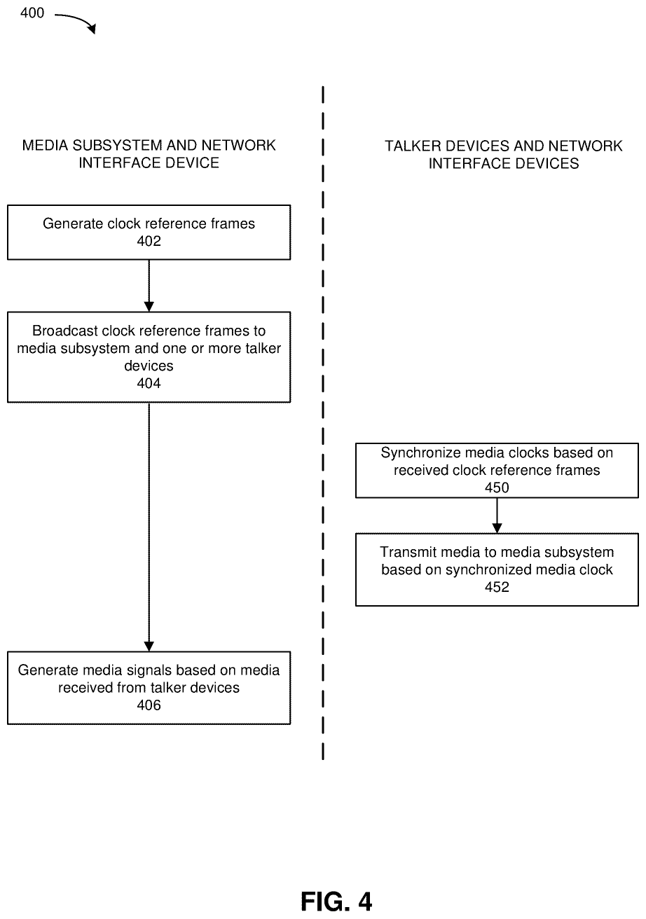

FIG. 4 shows an example process. The process can be performed by a media subsystem and/or one or more talker devices. At 402, a network interface device can generate clock reference frames timed to a clock signal. The network interface device can generate the clock signal based on network clock signals at least in accordance with IEEE 1588 PTP. The clock reference frames can indicate a timestamp value at which listener devices are to synchronize media clock signals with the timestamp value. At 404, the network interface device can transmit the clock reference frames to the talker devices and a receiver port of the network interface device. Based on a time stamp value in the clock reference frame, the receiver port of the network interface device can adjust a phase of a rising edge of the media clock to coincide with the time stamp value matching a network time stamp value counter.

At 450, a network interface device associated with a talker device can receive the clock reference frames. In a similar manner as that of the receiver port of the network interface device, based on a time stamp value in the clock reference frame, the network interface device can adjust a phase of a rising edge of the media clock to coincide with the time stamp value matching the network time stamp value counter. The network interface device can generate the time stamp value counter based on a network timer.

At 452, a talker device coupled to the network interface device, that synchronized a media clock based on the time stamp value in the clock reference frame, can transmit media to the media subsystem timed according to the media clock.

At 406, based on the media signals from the talker devices, the media subsystem can generate media signals. The media subsystem can output the media signals to one or more listener devices, such as a speaker, video display, headset, headphones, and/or other media devices.

FIG. 5 depicts a system. The system can use examples to configure clock signals based on clock reference frame signals, as described herein. In some examples, processor 510, graphics 540, one or more of accelerators 542, and/or network interface 550 can synchronize clock signals based on clock reference frame signals, as described herein. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die.

Accelerators 542 can be a fixed function or programmable offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 542 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as static random-access memory (SRAM), dynamic random-access memory (DRAM), or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 532 or driver can advertise capability of network interface 550 to configure clock signals based on clock reference frame signals, as described herein. In some examples, OS 532 or driver can enable or disable use of network interface 550 to configure clock signals based on clock reference frame signals, as described herein.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. In some examples, network interface 550 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory.

Some examples of network interface 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 550 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. A non-volatile memory (NVM) device is a memory whose state is determinate even if power is interrupted to the device.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a network interface device comprising: a direct memory access (DMA) circuitry; a device interface; a network interface; and a circuitry to: transmit a clock reference frame to multiple talker devices at a predefined rate to cause the multiple talker devices to synchronize clock signals with a time stamp value in the clock reference frame.

Example 2 includes one or more prior or later examples, wherein the circuitry is to synchronize a leading edge of a media clock signal based on the time stamp value and provide the media clock signal to an media processing system.

Example 3 includes one or more prior or later examples, wherein the media processing system is to provide a media signal, timed based on the media clock signal, to at least one speaker or display.

Example 4 includes one or more prior or later examples, wherein the multiple talker devices are to transmit media signals to the network interface device timed according to the synchronized clock signals and wherein the media system is to cause generation of media based on the provided media signals.

Example 5 includes one or more prior or later examples, wherein the circuitry is to generate the clock reference frame based on a clock signal adjusted based on Institute of Electrical and Electronics Engineers (IEEE) 1588 Precision Time Protocol (PTP).

Example 6 includes one or more prior or later examples, wherein the clock reference frame comprises an Institute of Electrical and Electronics Engineers (IEEE) 1722 Clock Reference Format (CRF) frame.

Example 7 includes one or more prior or later examples, wherein the circuitry is to transmit the clock reference frame to the multiple talker devices by at least one Ethernet packet.

Example 8 includes one or more prior or later examples, and includes a method that includes: transmitting a clock reference frame to multiple talker devices, in one or more Ethernet packets, to cause the multiple talker devices to synchronize clock signals with a time stamp value in the clock reference frame, wherein the multiple talker devices generate media data timed according to the synchronized clock signals.

Example 9 includes one or more prior or later examples, and includes synchronizing a media clock signal based on the time stamp value and providing the media clock signal to an media processing system.

Example 10 includes one or more prior or later examples, and includes receiving media signals from the multiple talker devices timed according to the synchronized media clock signal and providing a media signal, timed based on the media clock signal, to at least one speaker or display.

Example 11 includes one or more prior or later examples, and includes generating the clock reference frame based on a clock signal adjusted based on Institute of Electrical and Electronics Engineers (IEEE) 1588 Precision Time Protocol (PTP).

Example 12 includes one or more prior or later examples, wherein the clock reference frame comprises an Institute of Electrical and Electronics Engineers (IEEE) 1722 Clock Reference Format (CRF) frame.

Example 13 includes one or more prior or later examples, and includes at least one non-transitory computer-readable medium, comprising instructions stored thereon, that if executed by one or more processors, cause the one or more processors to: configure a network interface device to: transmit a clock reference frame to multiple talker devices, by one or more Ethernet frames, to cause the multiple talker devices to synchronize clock signals with a time stamp value in the clock reference frame and transmit media signals, from the one or more talker devices, to one or more listener devices.

Example 14 includes one or more prior or later examples, and includes instructions stored thereon, that if executed by one or more processors, cause the one or more processors to: configure the network interface device to: synchronize a media clock signal based on the time stamp value and provide the media clock signal to an media processing system.

Example 15 includes one or more prior or later examples, and includes instructions stored thereon, that if executed by one or more processors, cause the one or more processors to: configure the network interface device to: transmit media signals to one or more listener devices, wherein the media signals are timed based on the media clock signal.

Example 16 includes one or more prior or later examples, and includes instructions stored thereon, that if executed by one or more processors, cause the one or more processors to: configure the network interface device to: receive media signals from the multiple talker devices, wherein the media signals are timed according to the synchronized clock signals.

Example 17 includes one or more prior or later examples, and includes instructions stored thereon, that if executed by one or more processors, cause the one or more processors to: configure the network interface device to: generate the clock reference frame based on a clock signal adjusted based on Institute of Electrical and Electronics Engineers (IEEE) 1588 Precision Time Protocol (PTP).

Example 18 includes one or more prior or later examples, wherein the clock reference frame comprises an Institute of Electrical and Electronics Engineers (IEEE) 1722 Clock Reference Format (CRF) frame.

1. An apparatus comprising:
a network interface device comprising:
a direct memory access (DMA) circuitry;
a device interface;
a network interface; and
a circuitry to:
transmit a clock reference frame to multiple talker devices at a predefined rate to cause the multiple talker devices to synchronize clock signals with a time stamp value in the clock reference frame.

2. The apparatus of claim 1, wherein the circuitry is to synchronize a leading edge of a media clock signal based on the time stamp value and provide the media clock signal to an media processing system.

3. The apparatus of claim 2, wherein the media processing system is to provide a media signal, timed based on the media clock signal, to at least one speaker or display.

4. The apparatus of claim 2, wherein the multiple talker devices are to transmit media signals to the network interface device timed according to the synchronized clock signals and wherein the media system is to cause generation of media based on the provided media signals.

5. The apparatus of claim 1, wherein the circuitry is to generate the clock reference frame based on a clock signal adjusted based on Institute of Electrical and Electronics Engineers (IEEE) 1588 Precision Time Protocol (PTP).

6. The apparatus of claim 1, wherein the clock reference frame comprises an Institute of Electrical and Electronics Engineers (IEEE) 1722 Clock Reference Format (CRF) frame.

7. The apparatus of claim 1, wherein the circuitry is to transmit the clock reference frame to the multiple talker devices by at least one Ethernet packet.

8. A method comprising:
transmitting a clock reference frame to multiple talker devices, in one or more Ethernet packets, to cause the multiple talker devices to synchronize clock signals with a time stamp value in the clock reference frame, wherein the multiple talker devices generate media data timed according to the synchronized clock signals.

9. The method of claim 8, comprising:
synchronizing a media clock signal based on the time stamp value and
providing the media clock signal to an media processing system.

10. The method of claim 9, comprising:
receiving media signals from the multiple talker devices timed according to the synchronized media clock signal and
providing a media signal, timed based on the media clock signal, to at least one speaker or display.

11. The method of claim 8, comprising:
generating the clock reference frame based on a clock signal adjusted based on Institute of Electrical and Electronics Engineers (IEEE) 1588 Precision Time Protocol (PTP).

12. The method of claim 8, wherein the clock reference frame comprises an Institute of Electrical and Electronics Engineers (IEEE) 1722 Clock Reference Format (CRF) frame.

13. At least one non-transitory computer-readable medium, comprising instructions stored thereon, that if executed by one or more processors, cause the one or more processors to:
configure a network interface device to:
transmit a clock reference frame to multiple talker devices, by one or more Ethernet frames, to cause the multiple talker devices to synchronize clock signals with a time stamp value in the clock reference frame and
transmit media signals, from the one or more talker devices, to one or more listener devices.

14. The non-transitory computer-readable medium of claim 13, comprising instructions stored thereon, that if executed by one or more processors, cause the one or more processors to:
configure the network interface device to:
synchronize a media clock signal based on the time stamp value and provide the media clock signal to an media processing system.

15. The non-transitory computer-readable medium of claim 14, comprising instructions stored thereon, that if executed by one or more processors, cause the one or more processors to:
configure the network interface device to:
transmit media signals to one or more listener devices, wherein the media signals are timed based on the media clock signal.

16. The non-transitory computer-readable medium of claim 14, comprising instructions stored thereon, that if executed by one or more processors, cause the one or more processors to:
configure the network interface device to:
receive media signals from the multiple talker devices, wherein the media signals are timed according to the synchronized clock signals.

17. The non-transitory computer-readable medium of claim 13, comprising instructions stored thereon, that if executed by one or more processors, cause the one or more processors to:
configure the network interface device to:
generate the clock reference frame based on a clock signal adjusted based on Institute of Electrical and Electronics Engineers (IEEE) 1588 Precision Time Protocol (PTP).

18. The non-transitory computer-readable medium of claim 13, wherein the clock reference frame comprises an Institute of Electrical and Electronics Engineers (IEEE) 1722 Clock Reference Format (CRF) frame.
